(19) United States
(12) Patent Application Publication
(10) Pub. No.: US 2008/0047240 A1
(43) Pub. Date: Feb. 28, 2008

(54) Flexible Filter Element

(75) Inventors: Pius Trautmann, Dingolfing (DE); Michael Durst, Frankenhardt (DE)

Correspondence Address: CROWELL & MORING LLP;INTELLECTUAL PROPERTY GROUP, P.O. BOX 14300, WASHINGTON, DC, 20044-4300, US

(73) Assignee: Mann & Hummel GmbH, Ludwigsburg (DE)

(21) Appl. No.: 11/843,307

(22) Filed: Aug. 22, 2007

(30) Foreign Application Priority Data
Aug. 22, 2006 (DE) 10 2006 039 247.7

(51) Int. Cl. B01D 46/40; B01D 50/00

(52) U.S. Cl. 55/385.3; 55/497; 55/511

(57) ABSTRACT

A filter element, especially a filter element for filtering the air for the interior of a motor vehicle, having a filter insert acting as the filter medium with at least one strip which is arranged around the lateral edges of the filter insert so as to form a seal and at least a partial frame. The side strip has an adhesive layer on the side facing the filter insert. The adhesive layer is formed of an adhesive which a) has a Shore A hardness less than 65 at 23° C. and b) an elongation at break greater than 300%.

### BACKGROUND OF THE INVENTION

The present invention relates to a filter element, particularly a flexible filter element, for filtering air for the interior of a motor vehicle. The present invention further relates to a filter module.

A filter element of this kind is used to filter fluid flows or gaseous media, for example to filter an airflow supplied to the interior of a motor vehicle. Although applicable to any filter elements, the present invention and the underlying problem will be described with reference to a filter element for filtering air for the interior of a motor vehicle. Such filters are hereinafter also referred to as automotive interior air filters for short.

Increasing air pollution, particularly in large cities, combined with the use of modern air conditioning systems, makes it desirable and even necessary to use suitable filters to filter the outside air that is guided into the interior of a motor vehicle and treated or conditioned. Suitable for this purpose are, for example, particulate filters or odor filters or alternatively also combined particulate filters and odor filters, which filter out the particles contained in air and the odors inherent in the ambient air as well as possible. Such filters for filtering air for the interior of a motor vehicle are generally known in a wide variety of designs and variants, so that their construction and functioning will be described only briefly below.

Since the efficiency of filters depends particularly on the size of the filter surface through which the air flows, zigzag-folded filter media, also referred to as pleated filter media or accordion-folded filter media, are predominantly used for automotive interior air filters. Pleating the filter medium thus makes it possible to effectively increase the filter surface through which the airflow passes as a function of the fold height and the fold distance between the different fold sections of the filter medium. To make it easier to handle such filter elements with pleated or accordion-folded filter media particularly during assembly and installation, reinforcement elements (side strips) are provided. These reinforcement elements serve to laterally fix and stabilize the pleated filter medium and are applied to the lateral edges of the pleated filter medium using a suitable adhesive. The filter element with the reinforcements applied as strips to the folded longitudinal sides can thus be inserted easily during installation into a housing of a filter module or a corresponding recess formed in the interior paneling of a motor vehicle, for example. Such filter elements are described, for example, in German Patent Applications DE 10 2004 031 609 A1 and DE 103 21 068 A1as well as in U.S. Pat. No. 5,792,228 (=DE 195 45 046).

FIG. 1 shows such a conventional filter element with side strips.

If filter elements of this kind are used as automotive interior air filters, they must also be capable of being installed in specially provided recesses in the interior of the motor vehicle without too much effort and under difficult assembly and installation conditions. These filter elements must therefore be flexible because they sometimes have to be inserted into curved seats or housing parts. This also requires, on the one hand, that the side strips of the filter elements must be compressible and extensible in one direction (transverse direction) to allow them to be inserted into the correspondingly formed seat so that they fit and form a seal and, on the other hand, they must be as rigid as possible in the other direction (longitudinal direction).

The flexibility of filter elements is substantially determined by the flexibility of the adhesive used. As soon as the side strip has adequate flexibility independent of a ratio of maximum tensile force to elongation, the flexibility and compressibility of the element is determined by the type of application and the adhesive.

These filter elements must of course not only be easy to handle in terms of assembly and installation but must also be as inexpensive and thus as simple as possible to produce in terms of manufacture.

### SUMMARY OF THE INVENTION

It is therefore an object of the present invention to provide an improved flexible filter element.

Another object of the invention is to provide a filter element which has increased flexibility but is nevertheless stable.

It is a further object of the present invention to provide a filter element that is simple and cost effective to manufacture.

These and other objects are achieved in accordance with the present invention by providing a filter element comprising a filter insert which functions as a filter medium, and at least one side strip arranged around lateral edges of the filter insert so to as to form a seal and at least a partial frame, said side strip having an adhesive layer on the side facing the filter insert to sealingly join the strip to the filter insert, wherein the adhesive layer is formed of an adhesive which has a) a Shore A hardness less than 65 at 23° C., and b) an elongation at break greater than 300%.

In accordance with another aspect of the invention, the objects are achieved by providing a filter module comprising a filter housing and at least one filter element as described above inserted into the filter housing so as to form a seal between the filter insert and the housing.

Other advantageous embodiments are described hereinafter.

### BRIEF DESCRIPTION OF THE DRAWINGS

The invention will be described in greater detail with reference to illustrative preferred embodiments shown in the accompanying drawing figures, in which:

FIG. 1 is a perspective view of a filter element with side strips according to the prior art;

FIG. 2 is a view of a filter module according to the present invention with a filter element according to the invention inserted into a filter housing; and

FIGS. 3A to 3C are schematic illustrations of two possible embodiments of the filter module according to the invention, with FIG. 3B showing a section taken along line A-A in FIG. 3A.

### DETAILED DESCRIPTION OF PREFERRED EMBODIMENTS

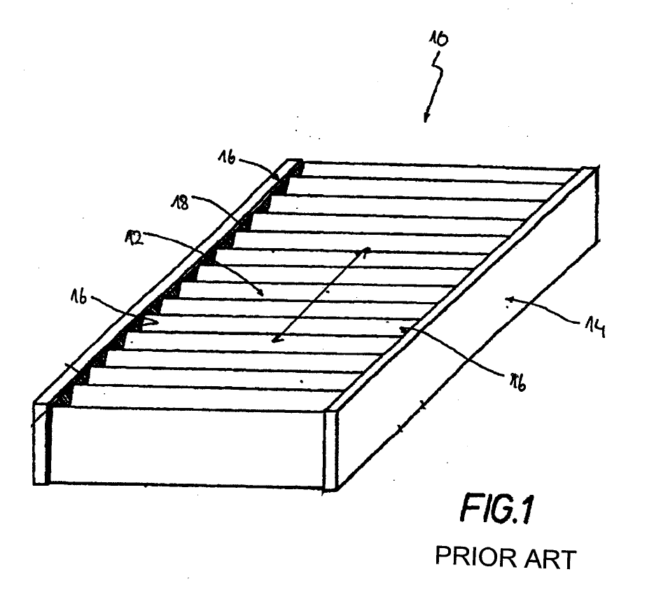

FIG. 1 shows a filter element 10 with side strips 14 according to the prior art; whereby it is assumed that the filter element 10 is configured as an air filter and particularly as an automotive interior air filter. The filter element 10 is constructed as a flexible filter element and to this end has a pleated filter insert 12 which acts as the filter medium. The pleated filter insert 12 is fixed in the filter element 10 by band-like side strips 14. In the example of FIG. 1, two band-like side strips 14 are provided, which adjoin lateral edges 16 of the filter insert and therefore enclose the filter insert 12 in a sandwich-like manner between the side strips 14. To secure the filter insert 12, the side strips 14 have an adhesive layer 18 on their side facing the filter insert 12. These side strips serve to reinforce the filter insert 12.

According to the invention it is proposed to use an adhesive with flexible properties for the manufacture of a filter element, particularly a filter element for filtering the airflow supplied to the interior of a motor vehicle. The flexibility can therefore be adjusted by the properties of the adhesive, so that the side strip merely serves as a support for the adhesive and as a sealing element.

The side strip is preferably formed of a synthetic nonwoven web, an elastomer, a flexible synthetic resin (i.e., plastic) material, a woven fleece material or the like. The side strip is approximately 0.5 to 15 mm, preferably 2 to 6 mm thick. The width of the side strip, which corresponds to the height of the filter element, is approximately 5 to 80 mm, preferably approximately 10 to 60 mm.

Suitable adhesives must have adequate ductility (the adhesive may of course not fracture). Moreover, the adhesive must have the characteristic of elastically returning to its initial state after loading without being plastically deformed to any considerable degree.

Suitable for this purpose are adhesives that meet the following characteristics: They have a) a Shore A hardness according to DIN 53505 of less than 65 at 23° C., and b) an elongation at break or tear according to ISO 527-3 greater than 300%, preferably greater than 400%.

One example of such an adhesive is Henkel's Q 4208 Paramelt Plastoflex. Persons skilled in the art will be able to find other examples.

In general, the adhesive layer is approximately 0.1 to 3.0 mm, preferably approximately 0.5 to 1.5 mm thick.

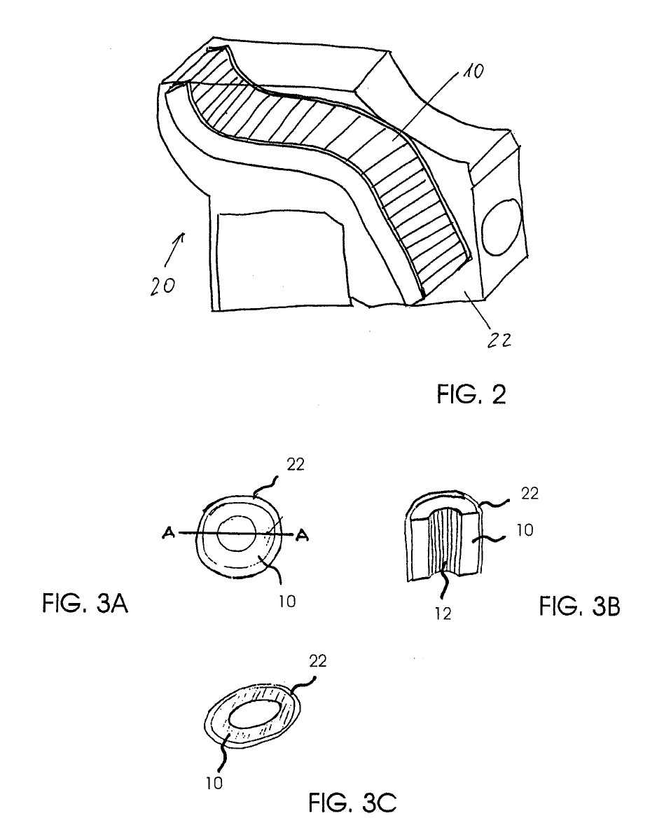

FIG. 2 shows a filter module 20 according to the invention with a filter housing 22, into which a filter element 10 according to the invention is inserted so as to form a seal.

In an embodiment of the filter module according to the invention shown in FIGS. 3A to 3C, the filter housing 22 of the filter module 20 with the at least one inventive filter element 10 has a round or oval cross section. FIG. 3B shows a section taken along line A-A of FIG. 3A.

The foregoing description and examples have been set forth merely to illustrate the invention and are not intended to be limiting. The present invention may be modified in many ways. In particular, the invention is not limited to filters for filtering gaseous media but may be used to great advantage also for filters intended to filter liquids. Nor is the invention necessarily limited to automotive filters but may be advantageously used in any other applications as well. Since modification of the described embodiments incorporating the spirit and substance of the invention may occur to persons skilled in the art, the invention should be construed broadly to include all variations within the scope of the appended claims and equivalents thereof.

What is claimed is:

1. A filter element comprising a filter insert which functions as a filter medium, and at least one side strip arranged around lateral edges of the filter insert so to as to form a seal and at least a partial frame, said side strip having an adhesive layer on the side facing the filter insert to sealingly join the strip to the filter insert, wherein the adhesive layer is formed of an adhesive which has
a) a Shore A hardness less than 65 at 23° C., and
b) an elongation at break greater than 300%.

2. A filter element as claimed in claim 1, wherein the elongation at break of the adhesive is greater than 400%.

3. A filter element as claimed in claim 1, wherein said at least one side strip is formed of a material selected from the group consisting of synthetic nonwoven webs, elastomers, flexible synthetic resin materials, and woven fleece materials.

4. A filter element as claimed in claim 1, wherein the side strip has a thickness of about 0.5 to 15 mm.

5. A filter element as claimed in claim 4, wherein the side strip has a thickness of about 2 to 6 mm.

6. A filter element as claimed in claim 1, wherein the side strip has a width of about 5 to 80 mm.

7. A filter element as claimed in claim 6, wherein the side strip has a width of about 10 to 60 mm.

8. A filter element as claimed in claim 1, wherein the filter insert is pleated in an accordion-like manner or zigzag-folded or is wave-shaped in the longitudinal direction.

9. A filter element as claimed in claim 1, wherein the side strip is secured to the filter insert by the adhesive layer at least along pleated lateral edges of the filter insert.

10. A filter element as claimed in claim 1, wherein said filter element comprises a particle and odor filter for filtering air for the interior of a motor vehicle.

11. A filter module comprising a filter housing and at least one filter element as claimed in claim 1 inserted into the filter housing so as to form a seal between the filter insert and the housing.

12. A filter module as claimed in claim 11, wherein the filter element is configured as an odor filter or a particle filter or both.

13. A filter module as claimed in claim 11, wherein the filter housing has a round or oval cross section.
